(19) United States
(12) Patent Application Publication
(10) Pub. No.: US 2006/0104214 A1
(43) Pub. Date: May 18, 2006

(54) System and method for automated provisioning of wireless access gateways

(76) Inventor: Michael S. Borella, Naperville, IL (US)

Correspondence Address: FELIX L. FISCHER, ATTORNEY AT LAW, 1607 MISSION DRIVE, SUITE 204, SOLVANG, CA, 93463, US

(21) Appl. No.: 10/993,464

(22) Filed: Nov. 18, 2004

(51) Int. Cl. H04L 12/56; H04L 12/28; H04L 12/66; H04Q 7/00

(52) U.S. Cl. 370/252; 370/352; 370/401; 370/229

(57) ABSTRACT

Provisioning of network wireless access gateways is provided through standard heartbeat communications between device management systems and the controlled devices. Security associations for use by the devices such as PDSNs in communication with other devices such as PCFs associated with the network is downloaded from the management system to the PDSNs in the heartbeat communication channel. Peer operation of the device management systems under a network management system allows input of the security authorizations at any of the management system levels with upload and download to peer components for transmission to their associated devices.

### BACKGROUND OF THE INVENTION

1. Field of the Invention

The present invention relates to communications in mobile Internet Protocol (“IP”) networks. More particularly, it relates to automated provisioning of components of wireless access gateways such as packet data serving nodes with IP addresses, secrets and SPIs for a plurality of packet control functions associated with radio network nodes.

2. Description of the Related Art

Public packet switched networks can be used to carry traffic to and from a mobile communications device (a mobile node) from one network to another. The basic architecture of mobile IP data networking is known in the art and described in several publications, including the Request for Comments (“RFC”) document RFC 2002 (1996) (hereinafter “RFC 2002”), which is currently available from the Internet Engineering Task Force (“IETF”) at www.ietf.org for more information. Persons skilled in the art of mobile IP data networking are familiar with that document and devices used to implement mobile IP data networking in practice.

In a mobile IP communication network, a mobile node communicates with a target host on an IP network by means of two devices, a “foreign agent” and a “home agent”. One example of a mobile IP network that describes that type of communication is presented in U.S. patent application Ser. No. 09/354,659 entitled “Mobile Internet Protocol (IP) Networking with Home Agent and/or Foreign Agent Functions Distributed Among Multiple Devices,” the entire content of which is incorporated herein by reference. Typically, the foreign agent functionality is incorporated into a router on a mobile node's visited network. The foreign agent provides routing services for the mobile node while it is registered with the home agent. For example, the foreign agent de-tunnels and delivers datagrams that were tunneled by the mobile node's home agent to the mobile node.

The home agent is typically incorporated into a router on a mobile node's home network. The home agent maintains current location information for the mobile node. When one or more home agents are handling calls for multiple mobile nodes simultaneously, the home agents are providing, in essence, a service analogous to a virtual private network service. Each mobile node is typically associated with a separate home network and the routing path from that home network, through the home agent, to the foreign agent and mobile node is like a virtual private network for the mobile node.

Mobile IP requires link layer connectivity between a mobile node (a mobile entity) and a foreign agent. However, in some systems, the link layer from the mobile node may terminate at a point distant from the foreign agent. Such networks are commonly referred to as third generation wireless networks. The block diagram of FIG. 1 illustrates a network architecture that is typically employed in the third generation wireless networks. Referring to FIG. 1, a mobile node 10 communicates with a target host 12 on an IP network 14 by means of three devices, a radio network node 16 which may include a packet control function (“PCF”), a packet data serving node 18, and a home agent node 20 that is resident in a home network 22. The physical layer of the mobile node 10 terminates on the radio network node 16, and the foreign agent's functionality resides on the packet data serving node 18 which is controlled through a foreign agent control node 24. The functionality of the foreign agent control node is described in U.S. patent application Ser. No. 09/881,649 entitled “System and Method for Managing Foreign Agent Selections in a Mobile Internet Protocol Network,” the entire content of which is incorporated herein by reference. A backup foreign agent control node 26 is also typically provided. Redundancy in the foreign agent control nodes to assure communications continuity is described in U.S. patent application Ser. No. 10/222676 filed Aug. 16, 2002 (MBHB CASE No. 02-318; 3Com Case No. 3879.CS.US.P ) entitled “System and Method for Foreign Agent Control Node Redundancy in an Internet Protocol Network” the entire content of which is incorporated herein by reference. Typically, the radio network node 16 relays link layer protocol data between the mobile node 10 and the packet data serving node 18, and the packet data serving node 18 establishes, maintains and terminates the link layer to the mobile node 10. For example, the mobile node 10 may be linked to the radio network node 16 via a communication link 32 on a radio access network.

The packet data serving node 18 provides routing services for the mobile node 10 while it is registered with the home agent 20. The packet data serving node 18 de-tunnels and delivers datagrams that were tunneled from the home agent node 20 via an IP network 28 to the mobile node 10. The communication traffic exchanged between the packet data serving node 16 and the home agent 20 includes data traffic as well as control traffic. The control traffic includes registration request or registration reply messages. The control and data traffic is routed via the packet data serving node 16 and terminates at the mobile node 10. The target host 12 may be connected to the home network 22 by any number of networks, such as the IP networks 14 and 28, or it may be directly located on the home network 22. Alternatively, the target host 12 may be connected to the home network by other types of packet switched networks.

The home agent 20 may be implemented on a router on the mobile node's home network 22. The home agent 20 maintains current location information data for the mobile terminal such as foreign agent address, a Network Access Identifier (“NAI”) of the mobile node 10, a mobile home address and a secret key shared between the home agent and the mobile node. The home agent tunnels data from the target host 12 to the packet data serving node 18, and similarly provides tunneling services in the reverse direction.

The home agent 20, therefore, typically implements at least two distinct tasks for the mobile node 10. First, the home agent 20 performs a registration and authentication process to determine whether the mobile node 10 is authorized to access the home network 22. This may involve, for example, checking the identification of the mobile entity, such as through the use of the mobile entity's unique serial number, NAI, or manufacturing number, password authentication, and possibly checking whether the mobile entity's account is current and paid. The home agent's registration and authentication function may be performed in conjunction with, or with the assistance of, a second device, such as an authentication, authorization and accounting (“AAA”) server such as a Remote Authentication Dial-In User Service (“RADIUS”) server 30. The registration process includes receiving and processing registration request messages from the packet data serving node 18 and sending registration reply messages to the packet data serving node 18.

The packet data serving node 18 also performs four distinct tasks for the mobile node 10. The packet data serving node 18 handles registration and session control for the mobile node 10, including sending registration request messages to the home agent 20 and processing registration reply messages received from the home agent. Additionally, the packet data serving node 18 has tunneling responsibilities for forwarding data packets to the home agent 20 for ultimate transmission to the target host 12, as well as de-tunneling data from the home agent 20 for ultimate delivery to the mobile node 10. Further, the packet data serving node 18 provides authentication, authorization and accounting services for the mobile node 10. The packet data serving node may perform the authentication, authorization and accounting functions in conjunction with, or with the assistance of, an authentication, authorization and accounting server, such as a RADIUS server. Additionally, the packet data service node 18 may provide Pi/FA interfaces that provide signaling/data interfaces to/from an AAA server, mobile switching center (“MSC”) or a home agent.

When the mobile node 10 initiates a communication session with the radio network node 16 by sending a call setup indication to the radio network node 16 across a radio communication link, the radio network node 16 initiates a registration process through the foreign agent control node 24 with the packet data serving node 18. Typically, the radio network node 16 is configured with one or more FACNs which control a number of packet data serving nodes that may provide services to the mobile node 10. The foreign agent control node 24 selects a packet data serving node based on memory usage, or processing power usage of the packet data serving node. During handoffs by the radio network node due to roaming by the mobile, the foreign agent control node must reselect a packet data serving node for communications with the mobile node. In general, it is desirable for the foreign agent control node to attempt to assign the same packet data serving node particularly where the roaming mobile node is subject to PCF only handoffs. Thus, once a mobile is assigned to a PDSN, the FACN will attempt to reassign the same PDSN no matter how many PCF handoffs occur. The mobile node may be assigned a different PDSN when the mobile logs off and then back on.

In present operational systems, provisioning of communication data, notably addresses, secrets and SPIs for communication with PCFs in the network, to packet data service nodes has been accomplished through manual configuration. In practice, dozens or hundreds of PDSNs are associated with each FACN pair and dozens or hundreds of PCFs are associated with each PDSN.

Thus, there is a need for improved system and method for provisioning packet data serving nodes in a mobile IP network.

### SUMMARY OF THE INVENTION

Provisioning of wireless access gateways in an Internet Protocol network is accomplished for a set of first managed components engaged in communication with a set of second managed components using an Element Management System (EMS) for the first managed components. An interface is provided between the EMS and the first managed components for heartbeat and control communication. Access authorization information for the set of second managed components is downloaded from the EMS to the first managed components over the interface. By employing a Network Management System (NMS) in communication with the EMS, the access authorization information for the set of second managed components is input to the NMS and pushed down from the NMS to the EMS. The EMS then converts the access authorization information to a format compatible with the first managed components.

Operation of invention with peer EMS systems is accomplished by providing a second EMS in communication with the NMS for the set of second managed components. An interface between the second EMS and the second managed components for heartbeat and control communication is provided and upon entry of the access authorization information into the NMS, it is pushed down to the second EMS, which converts the access authorization information a format compatible with the second managed components and downloads the access authorization information to the second managed components over the interface.

In the system with the NMS communicating with peer EMSs, inputting of access authorization information for the set of second managed components is conducted into the second EMS which converts the access authorization information to a generic format. The converted access authorization information is then uploaded from the second EMS to the NMS. The NMS then pushes down the access authorization information the peer EMS which converts the access authorization information to a format compatible with the first managed components and downloads the access authorization information to the first managed components over the interface.

In a selected embodiment of the invention, provisioning of wireless access gateways is accomplished through providing a first plurality packet data serving nodes (PDSNs) to act as foreign agents for mobile nodes communicating through a second plurality of radio network nodes. A foreign agent control node (FACN) is provided for redirecting incoming calls from a mobile node to a selected PDSN with an interface between the PDSNs and the FACN. Access authorization information for the plurality of radio network nodes is downloaded from the FACN to the PDSNs over the interface.

The radio network node employs packet control functions (PCF) and the authorization information includes PCF IP addresses, secrets and SPIs. Population of a table with authorization information for a plurality of PCFs by the PDSN is accomplished in the downloading and is initially accomplished with each PDSN upon heartbeat initialization by that PDSN. Subsequently, information update is accomplished responsive to a predetermined trigger such as updating a table of PCF addresses, secrets and SPIs in the FACN.

Indicators are employed for sensing a download for replacement of the entire table or for selective replacement of the information for each PCF. Notification of the FACN is accomplished by each PDSN of anomalies in the update.

To assure redundancy, a second FACN is connected to the interface with the PDSNs and downloading access authorization information for the plurality of radio network nodes from the first FACN to the second FACN is accomplished over a communication link.

These as well as other aspects and advantages of the present invention will become more apparent to those of ordinary skill in the art by reading the following detailed description, with reference to the accompanying drawings.

### BRIEF DESCRIPTION OF THE DRAWINGS

Exemplary embodiments of the present invention are described with reference to the following drawings, in which:

FIG. 1 is a functional block diagram illustrating an example of a mobile IP network architecture in which the present invention is implemented;

FIG. 2 is a block diagram of message sequencing for call flows employing an architecture with foreign agent: control nodes;

FIG. 3 is a block diagram of message sequencing for PDSN-FACN heartbeat initialization;

FIG. 4 is a block diagram of message sequencing for initial provisioning of PCF lists of PDSNs;

FIG. 5 is a block diagram of message sequencing for triggered update of PCF lists;

FIG. 6 is a block diagram of a network management system level implementation of the present invention;

FIG. 7 is a flow chart of the operational sequence for downloading security associations to the managed components; and,

FIG. 8 is a flow chart of the operational sequence for communicating security associations within the peer managed network.

### DETAILED DESCRIPTION OF THE INVENTION

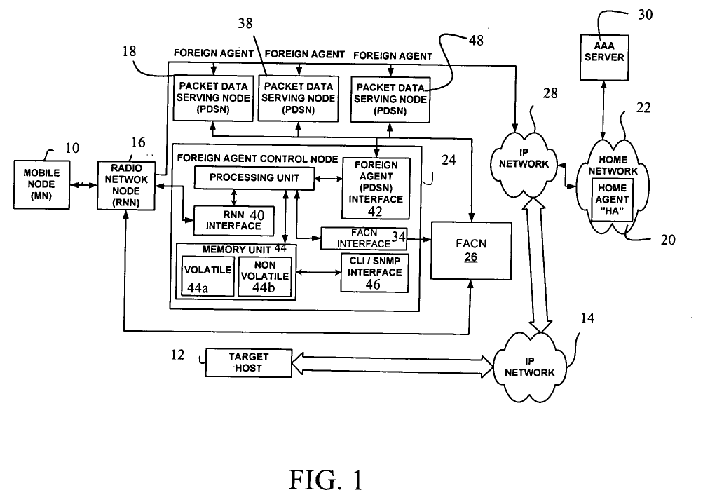

FIG. 1 is a functional block diagram illustrating an embodiment of a network system suitable for application of the present invention for provisioning the elements of the wireless access gateways in a mobile IP network. It should be understood that this and other arrangements and processes described herein are set forth for purposes of example only, and other arrangements and elements (e.g., interfaces, functions, order of elements, etc.) can be used instead and some elements may be omitted altogether. Further, as in most telecommunications applications, those skilled in the art will appreciate that many elements described herein are functional entities that may be implemented as discrete components or in conjunction with other components, in any suitable combination or location.

As shown in FIG. 1, a client device, such as a mobile node 10, communicates with a remote client device, such as the target host 12, on the IP network 14. The mobile node 10 is connected to a first network device, such as a radio node 16, via a radio connection 32 on a radio access network. In one embodiment, the radio node may include a radio network node (“RNN”), a base station control (“BSC”) node or a Packet Control Node (“PCN”), for example. As illustrated in FIG. 1, the radio node is referred hereinafter as a radio network node. According to one embodiment of the present invention, the radio network node 16 communicates with other network devices such as foreign agent control nodes (“FACN”) 24 and 26 and a plurality of packet data serving nodes (“PDSNs”). The FACN manages foreign agents selection, such as a packet data serving node selection for mobile IP registration purposes.

FIG. 1 illustrates the radio network node communicating with two foreign agent control nodes, foreign agent control node “1” 24 (hereinafter “FACN1”) and a foreign agent control node “2” 26 (hereinafter “FACN2”). However, it should be understood that the radio network node 16 may be configured to communicate with only one foreign agent control node or more than two foreign agent control nodes. Further, FIG. 1 illustrates a single radio network node; however, it should be understood that the mobile node 10 may roam between a plurality of radio network nodes configured to communicate with the FACN1 and the FACN2.

The FACN1 and FACN2 may communicate with each other via a communication link 34. It should be understood that the two FACNs and may be located on the same network entity. In such an embodiment, the communication link may be a communication link within a chassis, for instance. Alternatively, the two FACNs and may be located on different network entities. In such an embodiment, the communication link may include a wired communication link, a wireless communication link, or a combination thereof. Further, each FACN1 and FACN2 includes an inter-FACN interface that allows for communications with one or more FACNs. In one embodiment, the inter-FACN interface may be an Ethernet interface. However, different interfaces could also be used.

FACN1 and FACN2 communicate with a plurality of PDSNs. FIG. 1 illustrates multiple PDSNs; PDSN1 18 and a PDSN2 38 will be referred to in subsequent examples. However, it should be understood that each FACN may communicate with multiple PDSNs in multiple groups, as will be described subsequently, which provide load update information to each FACN. Further, the radio network node communicates with the PDSN1 and the PDSN2 that are connected to the IP network.

Describing exemplary communications using FACN1 as an example, FACN1 24 includes a radio node mobile IP interface 40 for communicating with radio network nodes, such as the radio network node 16. When the radio network node detects a call set up request from the mobile node, the radio network node requests mobile registration service from FACN1 over the radio network node interface 40. When FACN1 receives a registration request, FACN1 selects a third network device to provide network services to the mobile node 10. In one embodiment, FACN1 selects a PDSN using a set of predetermined criteria and sends the selected PDSN network address to the radio network node 16. FACN1 further includes a PDSN interface 42 for communicating with the pool of PDSNs, such as the PDSNs 18, 38, and 48. In the embodiment illustrated in FIG. 1, FACN1 communicates via the PDSN interface 42 with FACN-managed PDSNs. The PDSNs provide their capacity information capabilities, such as current call load factors, processing unit load factors, or memory load factors, via the PDSN interface.

In one specific embodiment, the PDSN interface 42 and the RNN interface 40 may be implemented in a Total Control Enterprise Network Hub commercially available from 3Com Corporation of Santa Clara, Calif. The Total Control product includes multiple network interface cards connected by a common bus. See “Modem Input/Output Processing Signaling Techniques,” U.S. Pat. No. 5,528,595, granted to Dale M. Walsh et al. for a description of the architecture of the Total Control product, which is incorporated herein by reference herein. However, the interfaces may also be implemented in other devices with other hardware and software configurations and are not limited to implementations in a Total Control product or the equivalent.

In the embodiment shown, FACN1 24 uses the capacity information of the managed PDSNs to determine the ability of a PDSN to handle a new mobile nodes registration. When the radio network node 16 registers the mobile node 10 with FACN1 as will be described subsequently, FACN1 may first attempt to assign the registering mobile node 10 to the PDSN currently providing communication services to the mobile node. However, if the FACN has no active history for the mobile node, or if the PDSN currently serving the mobile node is unavailable or invalid for the radio network node, a new PDSN is selected from a PDSN pool or group associated with the registering radio network node.

FACN1 further includes a memory unit 44. The memory unit includes a volatile memory unit 44A and a nonvolatile memory unit 44B. In one embodiment, before an FACN initiates processing of radio network node registration requests, the FACN is configured with a number of configuration records or tables that may be stored in the nonvolatile memory unit 44B or, alternatively, may be stored to a configuration file by a system administrator. In an embodiment where the nonvolatile records are stored in the configuration file, any subsequent FACN startups restore the configuration file. The configuration of the FACN is accomplished via a Command Line Interface (“CLI”) or a Simple Network Management Protocol (“SNMP”) interface 46. The CLI/SNMP interface provides a manner in which to add, delete and modify configuration entries. Any type of interface that provides an access for configuration may be used as an alternative to the CLI/SNMP interface. In one embodiment, a hardware platform for the FACN includes a Sun Microsystems Netra hardware platform.

One of the configuration tables in the nonvolatile memory 44B may include port numbers for exchanging control data between the FACN, the PDSNs and the radio network node. For example, the FACN may employ User Datagram Protocol (“UDP”) ports for exchanging control data with the PDSNs and the radio network node. The FACN may be configured to use an UDP port number 697 for exchanging data with the radio network node. The FACN may further be configured to use default UDP ports 15000 and 15001 for communicating control data with the PDSNs. However, it should be understood that the present invention is not limited to using these port numbers, and the FACN may employ different ports for communicating control data with the radio network node and PDSNs.

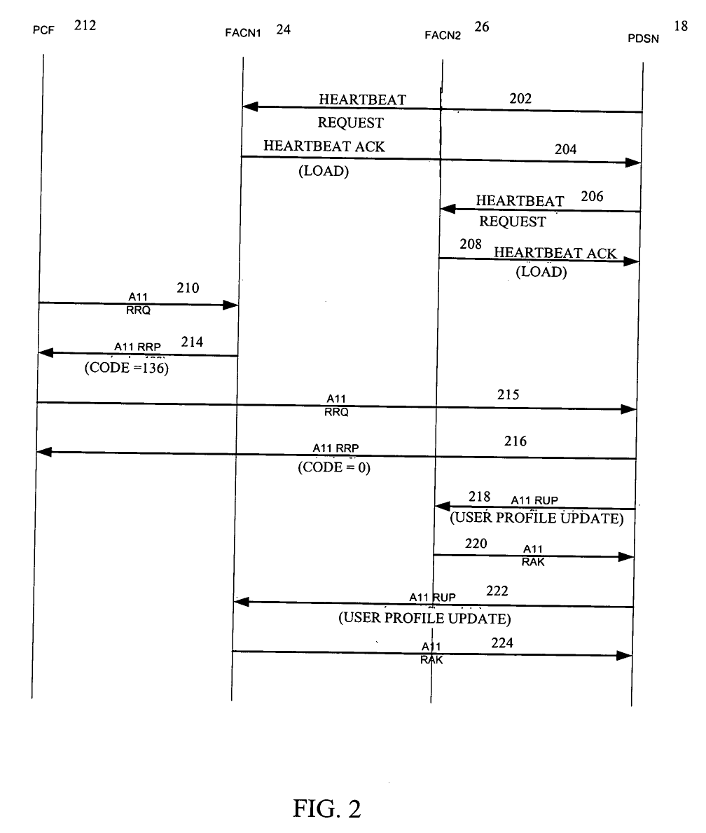

FIG. 2 demonstrates current call flow as handled by a primary and backup FACN.

PDSNs in the network exchange heartbeat information with both FACNs and the FACNs communicate via the PDSN interface. The exemplary PDSN1 18 sends a heartbeat request 202 to FACN1 24 which provides a heartbeat acknowledgement and load response 204. Similarly, the PDSN sends a heartbeat request 206 to FACN2 26 which responds with a heartbeat acknowledgement and load response 208. An incoming canonical A11 call results in an A11 request 210 from an exemplary PCF 212 of the Radio Network Node to FACN1 which provides an A11 response and code 214 designating a PDSN, in this example PDSN1 18. The PCF then transmits an A11 request 215 to PDSN1 which responds with an A11 response with appropriate code 216. PDSN1 provides a first user profile update 218 to one of the FACNs which then acknowledges 220 and a second user profile update 222 to the second FACN which acknowledges 224.

In this exemplary embodiment, the FACN will generally attempt to assign the same PDSN to mobile nodes that roam and are subject to PCF-only handoffs. As a result, as PCF hand-offs occur, the mobile node will be assigned to that PDSN regardless of the number of PCF hand-offs that occur. When the mobile node logs off and then back on, a different PDSN may be assigned by the FACN.

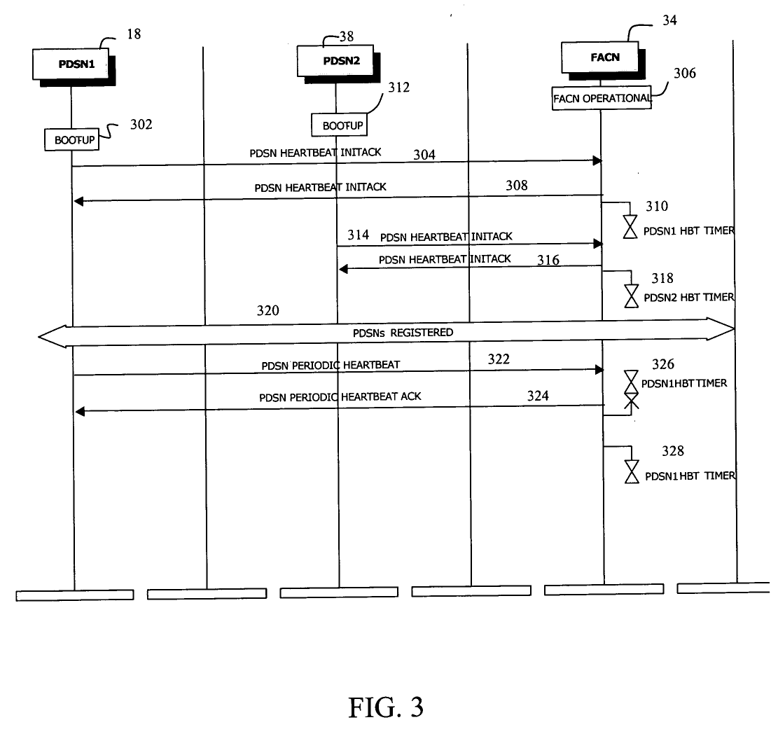

FIG. 3 provides additional detail of the initialization of the PDSN-FACN heartbeat for the embodiment disclosed herein for two exemplary PDSNs. Upon booting up 302, PDSN1 18 sends a heartbeat initialization message 304 to FACN1 24 which has previously conducted its own operational boot-up 306. The FACN responds to PDSN1 with a Heartbeat initialization acknowledgement 308. A heartbeat timer 310 is then set for receipt of periodic heartbeats from PDSN1 to confirm continued operation. Similarly, after PDSN2 38 boots up 312, a heartbeat initialization message 314 is sent to the FACN which responds with a heartbeat initialization acknowledgement 316 and sets a second heartbeat timer 318 for PDSN2. PDSN1 and PDSN2 join the pool of registered PDSNs 320 communicating with the FACN. During normal operation, prior to expiration of the PDSN heartbeat timer, PDSN1 sends a periodic heartbeat message 322 to the FACN which returns a periodic heartbeat acknowledgement message 324. The PDSN heartbeat timer is then turned off 326 and reset 328. PDSN2 communicates with the FACN in a similar manner.

The implementation of the present invention takes advantage of the heartbeat communication to provide provisioning information from the FACN to the PDSNs. Automatic provisioning of PCF IP addresses, secrets and SPIs are downloaded without the necessity of any a priori knowledge of the PCF(s) or their information by the PDSN. This capability allows adding of new PCF IP addresses, secrets and SPI information to the system elements of the network while it is running as well as the ability to dynamically delete entries from the PCF list and signal such removal information from the PDSN. Further, if desired, the ability to specify a default PCF secret and SPI to allow the network operator to configure multiple PCFs with the same secret and SPI is available.

Messaging to accomplish provisioning of PCF data is accomplished through two message formats for the FACN-PDSN interface. An information update is sent by the FACN to the PDSN and contains one or more PCF entries. The update message is not sent at regular intervals but initiated based on predefined triggers. The definition of this message is flexible to allow various information to be included. Specific elements of the embodiments described herein are exemplary of the provisioning information capability but are not exhaustive. In response to the information update, the PDSN sends and information update acknowledgement message to confirm receiving the information sent by the FACN.

Where PCF information is the data sent in the update message, the information update includes either a complete PCF list or a PCF list modification. Definition of the message type is accomplished by a bit in the message header or the inclusion of an attribute that indicates the type of update. For a complete list, the PDSN replaces its existing list with the new one. For a list modification, the PDSN adds or deletes PCF information to modify the previously provisioned list.

For the embodiment described herein, the PCF list format has each PCF IP address, secret and SPI formatted as an individual option in the FACN-PDSN interface. An initial list of entries is sent to each PDSN after the PDSN sends its heartbeat initialization message and the FACN has acknowledged. An exemplary format for the PCF list is shown in Table 1.

TABLE 1

| | | |
|---|---|---|
| RNN FACN Key = [value TBD] | | 1 |
| Length | | 2 |
| MSB | | 3 |
| PCF IP address | | 4 |
| | | 5 |
| | LSB | 6 |
| MSB | | 7 |
| SPI | | 8 |
| | | 9 |
| | LSB | 10 |
| MSB | | Variable |
| (PCF-PDSN Secret) \hat{ } (PDSN-FACN secret) | | |

In an exemplary reduction to practice, The PCF IP address 0.0.0.0 is to be interpreted as a default address. Thus, a secret and SPI associated with this address would be used for all PCFs that the PDSN communicates with that are not explicitly in the PDSN's PCF address list. For various embodiments, multiple default entries are legal, but each must have a different SPI. When a PCF entry is to be deleted, the format of the message will be the same but the option code for a deleted entry will be different, i.e. the first byte would be different for the add/modify and delete operations. This allows the same message to include both add and delete entries.

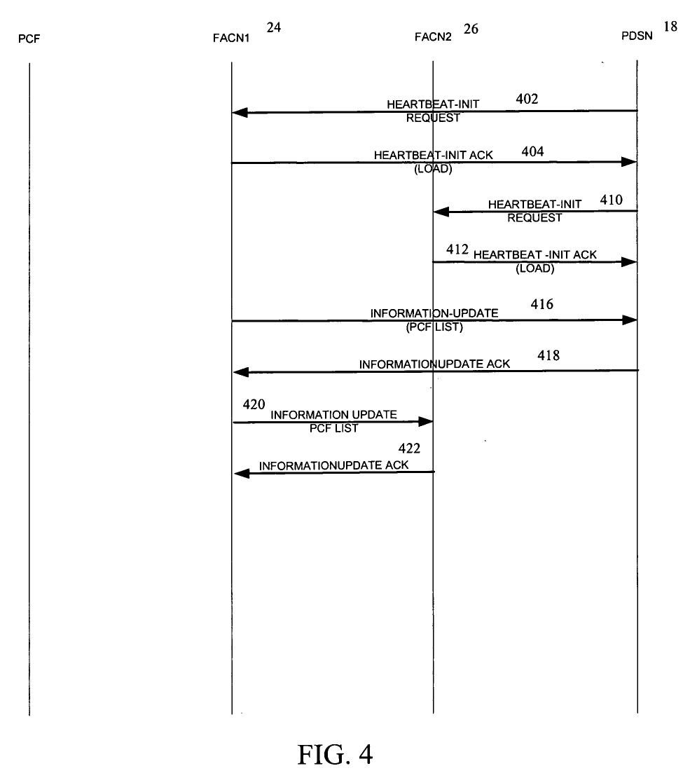

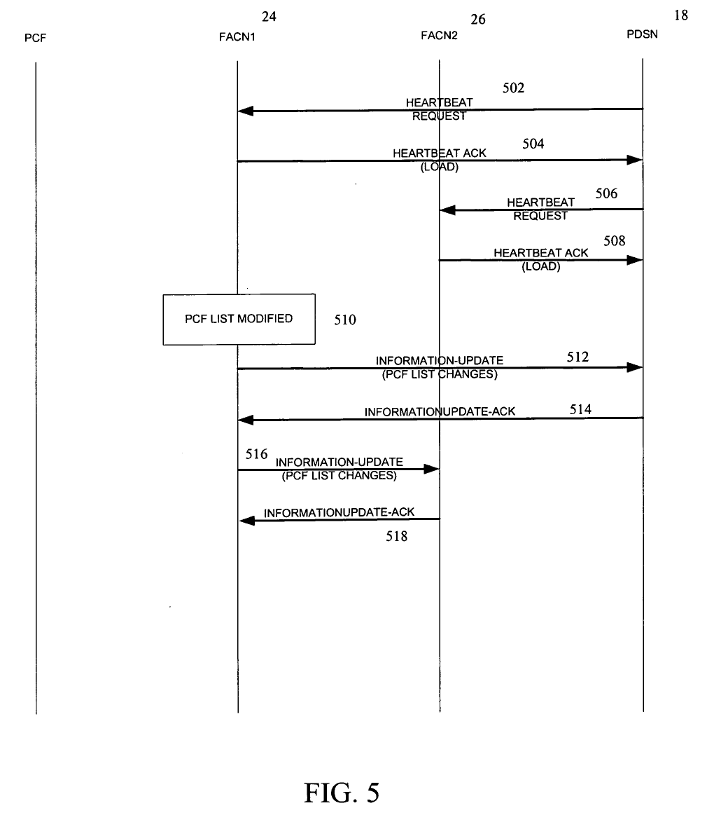

As will be described subsequently with respect to FIGS. 4 and 5, the PDSN acknowledges all information update messages received from the FACN with an information update acknowledgement. The ability to perform this automated provisioning is configurable in various embodiments on a per PDSN basis, and controlled via a CLI and other management interfaces. When a PDSN is configured to support automated provisioning, the PDSN accepts each PCF entry it receives from the FACN and populates the PCF table with the appropriate information as defined previously with respect to Table 1. When the PDSN send or receives an A11 message to or from a PCF for which it has an entry, it will use the associated SPI and secret for message authentication. If the PDSN receives a default PCF IP address (0.0.0.0), it will only fall back on this address along with its associated secret and SPI if the IP address of the PCF that it is communicating with does not exist elsewhere in the PCF table.

The PDSN accepts additional PCF entries in any information update message and properly adds these to the table. If there is a match between the PCF IP address and SPI of a new and an old entry, the new entry shall overwrite the old entry. For the embodiment described herein, the PDSN also may be statically configured with PCF addresses, secrets and SPIs, and then auto-provisioned. If there is a situation in which a static entry and an auto-provisioned entry have the same IP address and SPI but a different secret, the PDSN has a preconfigured option to overwrite the static entry with the auto-provisioned entry.

However, the PDSN is provided with alarms or warnings for anomalies such as an indication in the update message that a PCF entry should be deleted but that entry does not exist, the PDSN has overwritten a statically configured PCF entry, a PCF entry cannot be parsed or contains an invalid PCF IP address or there is a loss of heartbeat with a FACN when the PDSN relies on that FACN for its PCF update lists. For the embodiment disclosed herein, the alarm interface is SNMP.

If a PDSN loses contact with the FACN providing information updates, the current PCF list is maintained indefinitely. For the embodiment shown, if heartbeat is lost with one of the FACNs the backup FACN in communication with the PDSN commences supplying the PCF information updates upon receipt of the loss of heartbeat message.

Each FACN for the embodiment disclosed herein is provisioned with a list of PCF IP addresses, secrets and SPIs. Each of the entries in this list is able to be associated with one or more groups of PDSNs. Each PDSN group may include zero or more PDSNs. Further, each FACN is able to be provisioned while it is running so that PCF IP entries can be added to the list without re-starting the FACN. Modification of the PCF list on the FACN is a predefined trigger for the FACN to send the updated list to all of the applicable PDSNs. The PCF database is shared across the FACN-FACN interface via the existing heartbeat messages. When the PCF list is modified on the primary FACN, it is updated on the backup FACN.

FIG. 4 demonstrates a message sequence embodying the elements of the present invention with the heartbeat communications. As previously described with respect to FIG. 3, PDSN1 18 when booted requests heartbeat initialization 402 which is acknowledged 404 by FACN1 24. If the PDSN is so configured, it will also request heartbeat initialization 410 with FACN2 26 which will acknowledge 412. After registration of the PDSN, FACN1 sends an information update 416 which includes the PCF list for the PDSN group in which PDSN1 resides. PDSN1 responds with an acknowledgement 418. FACN1 also transmits the information update 420 to FACN2 which acknowledges 422. This remote provisioning of the PDSN configures PDSN1 with PCF addresses and associated secrets and SPIs for PDFs that will be redirected to the PDSN1 by FACN1 for communications with a mobile node.

Referring to FIG. 5, PDSN1 and the two FACNs continue periodic heartbeat communications as previously described with respect to FIG. 3 with PDSN1 sending periodic heartbeats 502, 506 and receiving heartbeat acknowledgements 504, 508 from FACN1 and FACN2 respectively. Upon modification of the PCF list 510 in FACN1, an information update 512 is sent to PDSN1 with the PCF list changes. PDSN1 responds with an information update acknowledgement 514. As with initial provisioning, FACN1 also sends an information update 516 to FACN2 with the PCF list changes which is acknowledged 518. As with the initial provisioning, PDSN1 will only receive updates from FACN1 for the PDSN group to which PDSN1 belongs while FACN2 will receive all updates.

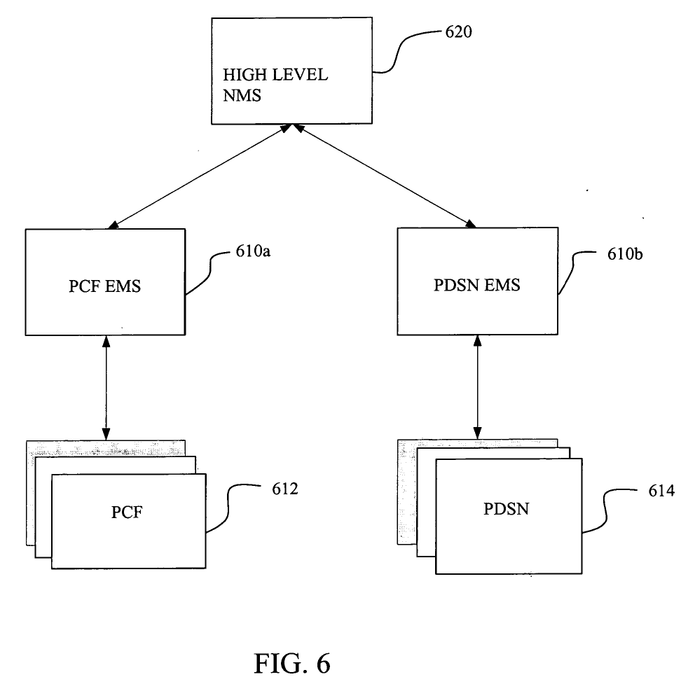

The present invention is also generalized for application at a network management system level as shown in FIG. 6 which discloses an exemplary network management architecture for a CDMA2000 wireless network. In a typical telecommunications network, each type of device has a dedicated element management system (EMS) 610a, 610b. The operator then can use a higher-level network management system (NMS) 620 that talks to all of the individual EMSs, to get a broad picture of the status of the network. For the embodiment shown, the set of PCFs 612 has a dedicated PCF EMS 610a, and the set of PDSNs 614 has a dedicated PDSN EMS 610b. Both EMSs are controlled by the higher-level NMS and operate in the system as peers.

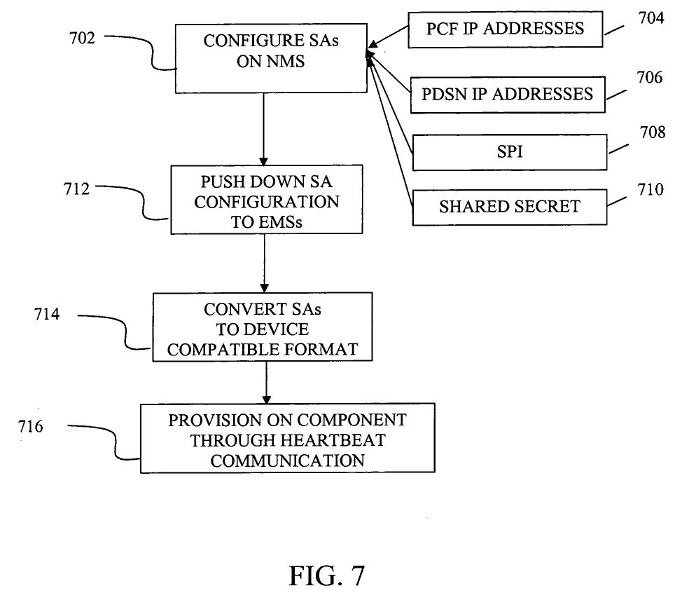

Automated provisioning of the security associations (SAs) on the PDSN and PCF occurs as shown in FIG. 7 wherein the operator configures a set of SAs on the NMS 702. Each SA includes one or more PCF IP addresses 704, one or more PDSN IP addresses 706, an SPI 708 and a shared secret 710. The NMS pushes the configuration down to each EMS 712. Each EMS then converts the configuration into a format usable by the managed component 714, and then provisions it on the managed component 716 through standard communication channels For the embodiment disclosed herein, the interface between the NMS and EMS elements is SNMP.

For the exemplary embodiment of FIG. 6, the NMS pushes the configuration to the PCF EMS 610a and the PDSN EMS 610b. The PCF EMS then converts the configuration of the set of SAs for application on the managed PCFs 612 and the PDSN EMS converts the configuration of the set of SAs for application on the managed PDSNs 614.

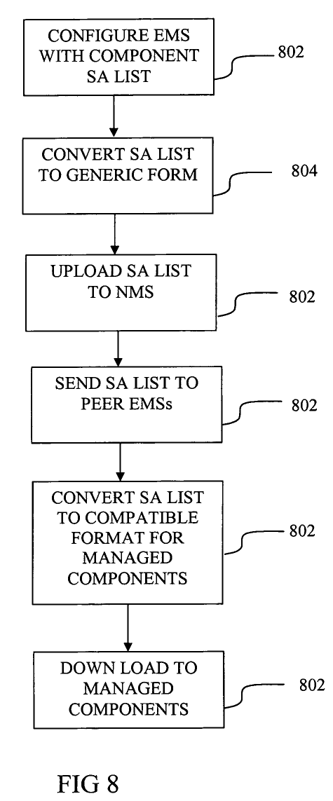

A similar procedure exists as an alternative if the SA set is configured directly on one of the EMSs instead. This procedure is shown in FIG. 8 wherein the operator configures the EMS with the component's SA list 802. The EMS automatically converts this list to a generic format i 5 804 and sends this list to the NMS 806. The NMS then sends this list to the peer EMS 808. The peer EMS converts this list to a format usable by the peer managed component 810 and pushes it down to the component 812. For the exemplary embodiment of FIG. 6, configuration of the PDSN EMS 610b with modified SAs results in the PDSN EMS converting the SA list to a generic form and transmitting to the NMS. The NMS in turn, pushes down the generic list to the PCF EMS 610a which then converts the SA list to a PCF format and passes it to the managed PCFs. Alternatively, the conversion of the SA list to generic form is accomplished in the NMS, however, communication of the NMS with EMSs in the system with generic forms implies that a conversion for the specifically managed components is present on each EMS and rendering this conversion bidirectional provides greatest efficiency.

In view of the wide variety of embodiments to which the principles of the present invention can be applied, it should be understood that the illustrated embodiments are examples only, and should not be taken as limiting the scope of the present invention. For example, the steps of the flow diagrams may be taken in sequences other than those described, more or fewer steps may be used, and more or fewer elements may be used in the block diagrams. While various elements of the preferred embodiments have been described as being implemented in software, in other embodiments in hardware or firmware implementations may alternatively be used, and vice-versa.

The claims should not be read as limited to the described order or elements unless stated to that effect. Therefore, all embodiments that come within the scope and spirit of the following claims and equivalents thereto are claimed as the invention.

What is claimed is:

1. A method for provisioning wireless access gateways in an Internet Protocol network, comprising the steps of:
providing a first plurality packet data serving nodes (PDSNs) to act as foreign agents for mobile nodes communicating through a second plurality of radio network nodes;
providing a foreign agent control node (FACN) for redirecting incoming calls from a mobile node to a selected PDSN;
providing an interface between the PDSNs and the FACN for heartbeat and control communication; and,
downloading access authorization information for the plurality of radio network nodes from the FACN to the PDSNs over the interface.

2. A method as defined in claim 1 wherein the radio network nodes include packet control functions (PCF) and the authorization information includes PCF IP addresses, secrets and SPIs.

3. A method as defined in claim 2 wherein the step of downloading comprises the steps of:
sending an information update from the FACN to the PDSNs; and,
acknowledging receipt of the information update by the PDSNs to the FACN.

4. A method as defined in claim 2 wherein the step of downloading includes population of a table with authorization information for a plurality of PCFs by the PDSN.

5. A method as defined in claim 3 wherein the step of sending an information update is accomplished to each PDSN upon heartbeat initialization by that PDSN.

6. A method as defined in claim 3 wherein the step of sending an information update is accomplished responsive to a predetermined trigger.

7. A method as defined in claim 6 wherein the predetermined trigger comprises updating a table of PCF addresses, secrets and SPIs in the FACN.

8. A method as defined in claim 4 wherein the step of downloading includes sensing an indicator for replacement of the entire table.

9. A method as defined in claim 4 wherein the step of downloading includes sensing indicators for selective replacement of the information for each PCF.

10. A method as defined in claim 4 further comprising the step of notifying the FACN by each PDSN of anomalies in the update.

11. A method as defined in claim 1 further comprising the steps of:
providing a second FACN connected to the interface with the PDSNs;
downloading access authorization information for the plurality of radio network nodes from the first FACN to the second FACN over a communication link.

12. A method as defined in claim 11 wherein the PDSNs conduct heartbeat communications with both the first and second FACN.

13. A method for provisioning wireless access gateways in an Internet Protocol network, comprising the steps of:
providing a first plurality first managed components engaged in communicating with a second plurality of second managed components;
providing an Element Management System (EMS) for the first managed components;
providing an interface between the EMS and the first managed components for heartbeat and control communication; and,
downloading security associations for the second plurality of second managed components from the EMS to the first managed components over the interface.

14. A method as defined in claim 13 further comprising the steps of:
providing a Network Management System (NMS) in communication with the EMS;
inputting security associations for the second plurality of second managed components to the NMS;
and wherein the step of downloading comprises the initial steps of:
pushing down the security associations from the NMS to the EMS; and
converting the security associations in the EMS to a format compatible with the first managed components.

15. A method as defined in claim 14 further comprising the steps of:
providing a second EMS in communication with the NMS for the second plurality of second managed components;
providing an interface between the second EMS and the second managed components for heartbeat and control communication;
pushing down security associations from the NMS to the second EMS;
converting the security associations in the second EMS to a format compatible with the second managed components; and
downloading security associations from the second EMS to the second managed components over the interface.

16. A method as defined in claim 13 further comprising the steps of:
providing a second EMS for the second plurality of second managed components;
providing a NMS in communication with the first and second EMS;
inputting security associations for the second plurality of second managed components into the second EMS;
converting the security associations in the second EMS to a generic format;
uploading the converted security associations from the second EMS to the NMS;
pushing down the security associations from the NMS to the EMS;
converting the security associations in the EMS to a format compatible with the first managed components; and
downloading the security associations from the EMS to the first managed components over the interface.
